(19) United States
(12) Patent Application Publication
(10) Pub. No.: US 2007/0289731 A1
(43) Pub. Date: Dec. 20, 2007

(54) METHOD FOR PROGRAMMING AND USER INTERFACE FOR ENVIRONMENTAL CONTROL

(75) Inventors: Jorge DELIGIANNIS, Ottawa (CA); Michael DELAGE, Ottawa (CA)

Correspondence Address: VINCENT PATENT AGENCY, 11-300 EARL GREY DRIVE, SUITE 202, KANATA, ON, K2T 1C1, CA

(73) Assignee: ENERGATE INC., Ottawa, ON (CA)

(21) Appl. No.: 11/755,213

(22) Filed: May 30, 2007

Related U.S. Application Data
(60) Provisional application No. 60/803,400, filed on May 30, 2006.

(51) Int. Cl. G05D 23/24

(52) U.S. Cl. 165/238

(57) ABSTRACT

A method for programming and a user interface for a programmable environmental control wherein a user assigns names (e.g. “Morning”, or “Unoccupied”, or “Evening”) to sets of parameters such as, for example, pairs of temperature set-points. When establishing the programming schedule, the user picks the name associated with the sets of parameters (e.g. a pair of set-points, one for heating and another for cooling) to be assigned to a given time period.

### CROSS-REFERENCE TO RELATED APPLICATIONS

This application claims priority from U.S. Provisional Patent Application Ser. No. 60/803,400 filed May 30, 2006, the entirety of which is incorporated herein by reference.

### FIELD OF INVENTION

The present invention relates to the field of programmable environmental controls. In particular, to a method for programming and a user interface for a programmable environmental control.

### BACKGROUND

Programmable environmental controls (e.g. thermostats) have the potential to provide end users with significant energy savings through set-back features, whereby indoor environment temperatures are allowed to swing more widely when a space is unoccupied, reducing the need to operate heating, ventilation, and air conditioning equipment, and thereby saving energy.

One of the problems with most programmable thermostats is that they are difficult for end-users to program. Some surveys have shown that as many as 50% of programmable thermostats have been permanently placed in a HOLD mode because users were unable to program their thermostats correctly.

The source of this problem can be traced to complex and non-intuitive programming methods, in combination with crude user interfaces, where users are forced to enter two temperature set-points (e.g. high/cooling and low/heating) for each time period in a weekly schedule. With most thermostats allowing at least four time periods per day, this can be difficult for users to keep track of. While some manufacturers have implemented features allowing users to copy one day's schedule to another, the programming user interfaces remain complex and difficult to use.

When other parameters, such as humidity or fan operation can also be programmed for each period in the same schedule this becomes an increasingly unwieldy method.

FIG. 1 is a schematic representation of prior art approach to programming a thermostat. A typical current solution for programming uses a system where each day has 4 to 6 timeslots. Each timeslot has a modifiable start time, heating, and cooling set-point. Often these timeslots are named: the first timeslot of the day is “Wake”, the second “Leave”, the third “Return”, and the fourth “Sleep”, but these names cannot be edited or the order changed. As a result, even though “Wake” and “Return” might have exactly the same heating and cooling set-points, they will be referred to by different names, which can cause confusion. Also, the number of timeslots per day may not be variable.

The user programs their weekly schedule by going through each day and setting the start time and heating and cooling set-points for each timeslot of each day (28 or more timeslots for a 7-day programmable thermostat) 101. Many thermostats incorporate a “copy” mechanism which allows the user to copy 102 the program from one day to the next in order to speed programming, but this mechanism has limitations when making modifications to the desired heating or cooling set-points for a given time.

For example, to change the heating set-point for all the “Return” timeslots, the user would have to go to one day, make the change and then copy that day to the other days where the change applied. If there were differences in other timeslots between days, then the copy function can not be used and each day would have to be changed individually 103.

### SUMMARY OF INVENTION

A method for programming and a user interface for a programmable environmental control wherein a user assigns names (e.g. “Morning”, or “Unoccupied”, or “Evening”) to sets of parameters such as, for example, pairs of temperature set-points. When establishing the programming schedule, the user picks the name associated with the sets of parameters (e.g. a pair of set-points, one for heating and another for cooling) to be assigned to a given time period.

In accordance with an aspect of the invention there is provided a method for programming an environmental control comprising the steps of: assigning names to each of one or more parameter sets; associating one of the named parameter sets with each of one or more start times for each day of the week; wherein the environmental control applies the named parameter set when each of the one or more start times occurs in each day of the week.

In accordance with another aspect of the invention there is provided a user interface for programming an environmental control comprising: a mechanism for assigning names to each of one or more parameter sets; a mechanism for associating one of the named parameter sets with each of one or more start times for each day of the week; wherein the environmental control applies the named parameter set when each of the one or more start times occurs in each day of the week.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is a schematic representation of a prior art approach to programming a thermostat.

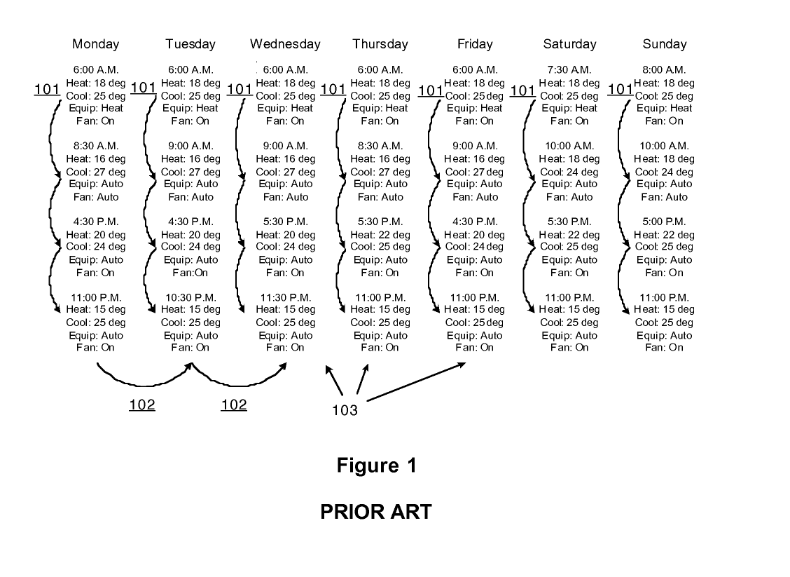

FIG. 2 is a schematic representation of an exemplary embodiment of a method for programming and a user interface for programming an environmental control.

FIG. 3 is a flow diagram of steps in an exemplary embodiment of a method of programming an environmental control.

### DETAILED DESCRIPTION

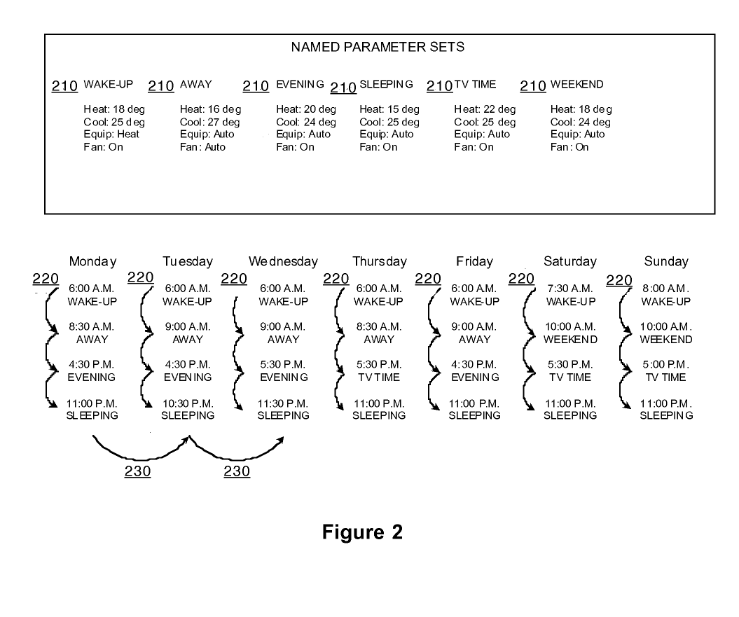

FIG. 2 is a schematic representation of an exemplary embodiment of a method for programming and a user interface for programming an environmental control (e.g. a thermostat). The method for programming and the user interface for a programmable environmental control allows a user to assign names 210 (e.g. “Morning”, or “Unoccupied”, or “Evening”) to sets of parameters such as, for example, pairs of temperature set-points, one for heating and another for cooling. When establishing the programming schedule, the user need only pick the name associated with the set of parameters (e.g. pair of set-points) to be assigned to a given time period 220. The time period can be represented by a start time for a particular day of the week.

The environmental control can incorporate a keypad, a touch sensitive panel, a computing device interface, a data networking interface, or other similar well known mechanism to allow the user to enter the assigned names and to support the other user interactions with the environmental control described below.

For example, on Tuesday at 6:30 a.m., the user can select “Morning”. At 9:00 a.m., the user can select “Unoccupied”, and so on for each day, possibly with different times. A default program can also be installed at the factory complying, for example, with EnergyStar™ requirements. The user can also copy 230 all of the start times and associated named parameter sets from one day of the week to another day of the week.

The method and user interface provide ease to the user in modifying an environmental control program. If a user decides that their “Evening” temperatures are too hot or too cold, the user can simply modify the temperature set-points associated with that name, and then wherever the “Evening” name appears in the schedule, it will be modified. This saves the user from having to modify each applicable timeslot in the schedule individually.

The method and user interface allow the user to modify the names associated with set-points to ones of the user's choosing, that the user can more easily relate to, such as, for example, “TV Time” or “Sleeping”.

The method and user interface permit re-use of a named parameter set several times in a given day. For example, when a user has only “Home” and “Away” named parameter sets, the named parameter sets can each be used several times during the day to accommodate the user's behavior.

In an alternative embodiment in addition to associating temperature set-points with names, other control parameters, such as equipment mode or fan mode, humidity, air quality and energy efficiency settings can also be associated with names. Energy efficiency settings can, for example, include information related to variable electricity rates such as time-of-day based rates.

In a multi-sensor environmental control system, each of the named parameter sets can also have a selection of associated sensors, for example in a residential setting, “Morning” can have the bedroom and kitchen sensors selected, while “Sleeping” can have only the bedroom sensor selected, and “Evening” could have the living room sensor selected.

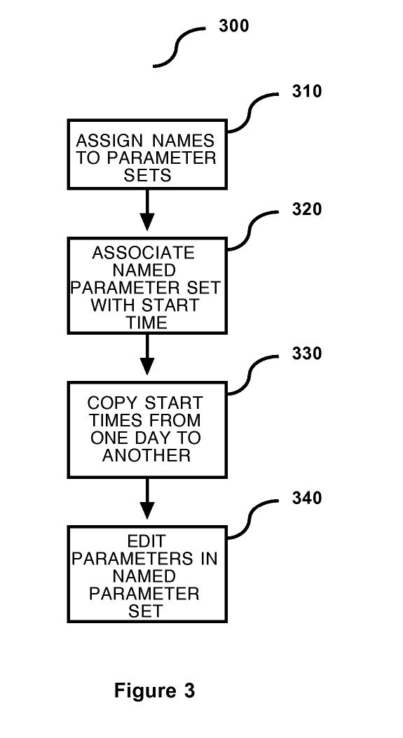

FIG. 3 is a flow diagram of steps in an exemplary embodiment of the method 300 of programming an environmental control. A user can assign names 310 to each of one or more parameter set. Each parameter set can include, for example, a high temperature set-point and a low temperature set-point. Each parameter set can include other control parameters such as, for example, equipment mode, fan mode, humidity and air quality settings. In a multi-sensor environmental control system, each parameter set can also be associated with a selection of sensor representing all or a subset of the sensors in the system. One of the named parameter sets can be associated 320 with each of one or more start times for each day of the week. The user can enter the start times. The start times can differ from one day of the week to another day of the week. The parameter set associated with a start time is applied by the environmental control from the occurrence of the start time until the occurrence of the next start time in the same day of the week or in another day of the week. The user can copy 330 the start times for a source day of the week to a destination day of the week. The named parameter sets associated with the start times in the source day of the week are associated with the corresponding start times in the destination day of the week. The user can edit 340 the parameters in any of the named parameter sets. Changes made to a named parameter set apply to each start time, in every day of the week, that is associated with that named parameter set.

The method according to the present invention can be implemented by a computer program product comprising computer executable instructions stored on a computer-readable storage medium.

It will be apparent to one skilled in the art that numerous modifications and departures from the specific embodiments described herein may be made without departing from the spirit and scope of the present invention.

1. A method for programming an environmental control comprising the steps of:
assigning names to each of one or more parameter sets;
associating one of the named parameter sets with each of one or more start times for each day of the week;
wherein the environmental control applies the named parameter set when each of the one or more start times occurs in each day of the week.

2. The method of claim 1 further comprising the step of:
copying the one or more start times for a source day of the week to a destination day of the week;
wherein the named parameter sets associated with each of the one or more start times for the source day of the week are associated with the corresponding one or more start times for the destination day of the week.

3. The method of claim 1 further comprising the step of:
editing the parameters in a named parameter set;
wherein changes made to the parameters apply to all start times for each day of the week that are associated with the named parameter set.

4. The method of any of claims 1 to 3, wherein each parameter set includes a high temperature set-point and a low temperature set-point.

5. The method of any of claims 1 to 3, wherein each parameter set includes settings for any one or more of: equipment mode, fan mode, humidity, air quality and energy efficiency.

6. The method of any of claims 1 to 3, wherein the environmental control has a plurality of sensors and each parameter set includes a selection of sensors from the plurality of sensors.

7. A user interface for programming an environmental control comprising:
a mechanism for assigning names to each of one or more parameter sets;
a mechanism for associating one of the named parameter sets with each of one or more start times for each day of the week;
wherein the environmental control applies the named parameter set when each of the one or more start times occurs in each day of the week.

8. The user interface of claim 6 further comprising:
a mechanism for copying the one or more start times for a source day of the week to a destination day of the week;
wherein the named parameter sets associated with each of the one or more start times for the source day of the week are associated with the corresponding one or more start times for the destination day of the week.

9. The user interface of claim 6 further comprising:
a mechanism for editing the parameters in a named parameter set;
wherein changes made to the parameters apply to all start times for each day of the week that are associated with the named parameter set.

10. The user interface of any of claims 7 to 9, wherein the each parameter set includes a high temperature set-point and a low temperature set-point.

11. The user interface of any of claims 7 to 9, wherein each parameter set includes settings for any one or more of: equipment mode, fan mode, humidity, air quality and energy efficiency.

12. The user interface of any of claims 7 to 9, wherein the environmental control has a plurality of sensors and each parameter set includes a selection of sensors from the plurality of sensors.
